(19) United States
(12) Patent Application Publication
(10) Pub. No.: US 2019/0048164 A1
(43) Pub. Date: Feb. 14, 2019

(54) BENZOXAZINE BASED COPOLYMER AEROGELS

(71) Applicants: Henkel IP & Holding GmbH, Duesseldorf (DE); Henkel AG & Co. KGaA, Duesseldorf (DE)

(72) Inventors: Elisabet Torres Cano, Barcelona (ES); Fouad Salhi, Farmington, CT (US); Camilo Javier Zuniga Ruiz, Barcelona (ES); Joaquim Torres Sanglas, Barcelona (ES); Maria Lourdes Vega Fernandez, Barcelona (ES); Asta Sakalyte, Sant Salvador (Tarragona) (ES)

(21) Appl. No.: 16/160,085

(22) Filed: Oct. 15, 2018

Related U.S. Application Data
(63) Continuation of application No. PCT/EP2017/058836, filed on Apr. 12, 2017.

(30) Foreign Application Priority Data
Apr. 13, 2016 (EP) 16165082.5

(51) Int. Cl. C08J 9/28; C08G 73/02; F16L 59/00; G10K 11/162

(52) U.S. Cl. CPC C08J 9/286; C08G 73/0233; C08G 2101/0091; G10K 11/162; F16L 59/00

(57) ABSTRACT

The present invention relates to a benzoxazine based copolymer aerogel obtained by reacting a benzoxazine monomer or oligomer and a comonomer selected from the group consisting of an isocyanate compound, a cyclic ether compound and an acid anhydride compound in a presence of a catalyst and a solvent, wherein said catalyst is an optional ingredient when said comonomer is an acid anhydride compound or an isocyanate compound. Benzoxazine based copolymer aerogel according to the present invention provides high thermal insulation material, while good mechanical properties and performance is maintained.

### TECHNICAL FIELD

The present invention relates to a benzoxazine based copolymer aerogel obtained by reacting a benzoxazine monomer or oligomer and a comonomer selected from the group consisting of an isocyanate compound, a cyclic ether compound and an acid anhydride compound. The benzoxazine based aerogels according to the present invention provide high thermal insulation material, while maintaining good mechanical properties and performance.

### BACKGROUND OF THE INVENTION

Aerogels are three-dimensional, low-density assemblies of nanoparticles derived from drying wet-gels by exchanging the pore-filling solvent to a gas, usually with a supercritical fluid. By these means, the capillary forces exerted by the solvent due to evaporation are minimized, and structures with large internal void space are achieved. The high porosity of these materials is reason for their very low thermal conductivity, which makes aerogels extremely attractive materials for thermal insulating applications.

Compared to common thermal insulators in the market, aerogels are lightweight materials with a very low thermal conductivity. Therefore, aerogels are known for being good insulating materials due to their nanostructure, and the elimination of any contribution from the gas phase. Thus, thickness of the insulating layer can be reduced while obtaining similar insulating properties. Aerogels are environmentally friendly because they are air filled.

Thermal insulation is important in many different applications in order to save energy and reduce costs. Examples of such applications are construction, transport and industry. For some applications, it is possible to use a thick insulating panel to reduce the heat transfer. However, other applications may require thinner insulating panels and/or layers because of size limitations. For the thin insulating panels/layers the thermal conductivity of the material has to be extremely low in order to get the same insulating properties than with thicker insulating panels and/or layers. Additionally, in some cases and depending on the application, high mechanical properties may also be required.

Most of known aerogels are inorganic aerogels, which are mainly based on silica. Despite of their high thermal insulating properties, a slow commercialization has been observed due to their fragility and poor mechanical properties. This fragility may be overcome by different methods. For example, by cross-linking aerogels with organic polymers or by post-gelation casting of a thin conformal polymer coating over the entire internal porous surface of the preformed wet-gel nanostructure. Moreover, inorganic aerogels are brittle, dusty and easy air-borne, and therefore, cannot withstand mechanical stress. Because of that, sometimes they are classified as hazardous materials. In addition, due to their brittleness, they are not suitable for some applications where mechanical properties are required.

On the other hand, different organic aerogels have also been described in the literature. These materials are generally based on polymeric networks of different nature, formed by cross-linking of monomers in a solution to yield a gel, which is subsequently dried to obtain a porous material. Organic aerogels are robust and mechanically stable, which is an advantage for many applications. However, some of these materials can also have drawbacks.

First organic aerogels described in the literature were based on phenol-formaldehyde resins, which can also be used to prepare carbon aerogels by pyrolysis. Resorcinol-formaldehyde aerogels are brittle and their curing process takes a long time (up to 5 days), which results a drawback for an industrial scale production. Other significant organic aerogels are based on materials prepared using multifunctional isocyanates, which have faster curing process, and their mechanical properties can be modified. Mechanical properties depend on the reacting functional group with the isocyanate moiety, as well as the monomer and/or oligomer chemical structure (i.e. number of functionalities, aromatic or aliphatic nature, steric hindrance, etc.).

Amongst thermosetting resins, polybenzoxazines have been developed to overcome many of the limitations of the above mentioned resorcinol-formaldehyde resins. Polybenzoxazines not only combine advantages of resorcinol-formaldehyde (e.g. inherent flame retardancy and thermal properties) but also present additional features, such as near zero volumetric change upon polymerization, no volatile release during curing, low water absorption and low coefficient of expansion. Based on these properties, it is now recognized that polybenzoxazine is not to be considered as simply a replacement material for the traditional phenolic resins, but as a class of materials that goes beyond of other thermosetting resins including epoxy and bismaleimide resins.

Although pure polybenzoxazines offer a variety of advantages, they are brittle materials. To overcome this drawback, benzoxazines have been copolymerized with other monomers. Properties of rendered blends can be tailor-made to meet desired requirements. Mixtures of benzoxazines and comonomers such as epoxy resins, dianhydrides, dicarboxylic acids, diisocyanates and phenolic resins are known. Further, bio-based cross-linked polymers based on chitosan and polybenzoxazine, synthesized in aqueous medium are known in the art. These copolymeric materials seem to be useful in application amongst different industries such as the automotive, aerospace or electronic.

Based on the profitable benzoxazine chemistry, their outstanding properties and the capability to be copolymerized with many comonomers, benzoxazine-based copolymer aerogels provide an alternative to resorcinol-formaldehyde counterparts. In fact, benzoxazine moiety-containing polybenzoxazine aerogels have been proposed. Aerogels are prepared from the reaction of an aryl alcohol, an amine, and aldehyde, followed by CO₂ supercritical drying. Although these aerogels present a low thermal conductivity, they are said to be brittle and may collapse by small impacts.

Therefore, there is still a need for benzoxazine based copolymer aerogels, which are providing good thermal insulation properties, while being mechanically robust.

### SUMMARY OF THE INVENTION

The present invention relates to a benzoxazine based copolymer aerogel obtained by reacting a benzoxazine monomer or oligomer and a comonomer selected from the group consisting of an isocyanate compound, a cyclic ether compound and an acid anhydride compound in a presence of a catalyst and a solvent, wherein said catalyst is an optional ingredient when said comonomer is an acid anhydride or an isocyanate compound.

The present invention also relates to a method for preparing a benzoxazine based copolymer aerogel according to the present invention comprising the steps of: 1) dissolving a benzoxazine monomer or oligomer, comonomer and a catalyst into a solvent and mixing, 2) transferring the mixture of step 1) to a sealed mould; 3) heating the solution in order to form a gel; 4) washing said gel with a solvent; 5) drying said gel by supercritical or ambient drying; and 6) postcuring of the obtained aerogel by thermal treatment.

The present invention encompasses a thermal insulating material or an acoustic material comprising a benzoxazine based copolymer aerogel according to the present invention.

In addition, the present invention encompasses use of a benzoxazine based copolymer aerogel according to the present invention as a thermal insulating material or acoustic material.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skill in the art to which this invention belongs to. By means of further guidance, term definitions are included to better appreciate the teaching of the present invention.

The present invention relates the development of a benzoxazine based copolymer aerogel obtained by reacting a benzoxazine monomer or oligomer and a comonomer selected from the group consisting of an isocyanate compound, a cyclic ether compound and an acid anhydride compound in a presence of a catalyst and a solvent, wherein said catalyst is an optional ingredient, when said comonomer is an acid anhydride or an isocyanate compound.

A highly cross-linked polymeric network is formed, which gels in a presence of a solvent. After drying in supercritical or ambient conditions, lightweight aerogels are obtained with pore sizes in the range of tens to hundreds of nanometres. Very low thermal conductivity values are shown in combination with good mechanical performance, which represents the most difficult property to obtain in highly porous materials.

The Applicant has discovered that the benzoxazine based copolymer aerogels according to the present invention provide high thermal insulation material, while good mechanical properties and performance are maintained. Furthermore, the benzoxazine based copolymer aerogels according to the present invention provide adjustable mechanical performance; aerogels can be designed to be rigid or flexible.

By the term ‘aerogel’ is meant herein a synthetic porous, low-density material derived from a gel, in which a gas has replaced the liquid component of the gel. Due to their high porosity and low density, these materials generally present low thermal conductivity.

By the term ‘gel’ is meant herein is a solid, jelly-like soft material, having a substantially dilute cross-linked system, which exhibits no flow when in the steady state.

In order to prepare benzoxazine-based copolymer aerogels, benzoxazine monomer or oligomers are reacted with different comonomers including oxetanes, epoxy resins, acid anhydrides or isocyanates allowing the formation of highly crosslinked networks as illustrated in the scheme 1 below. Copolymerization reaction between benzoxazine resins and any kind of comonomer takes place between free phenolic hydroxyl functionalities with the corresponding reactive group of the selected comonomer (e.g. oxyrane or oxetane rings, anhydride and isocyanate).

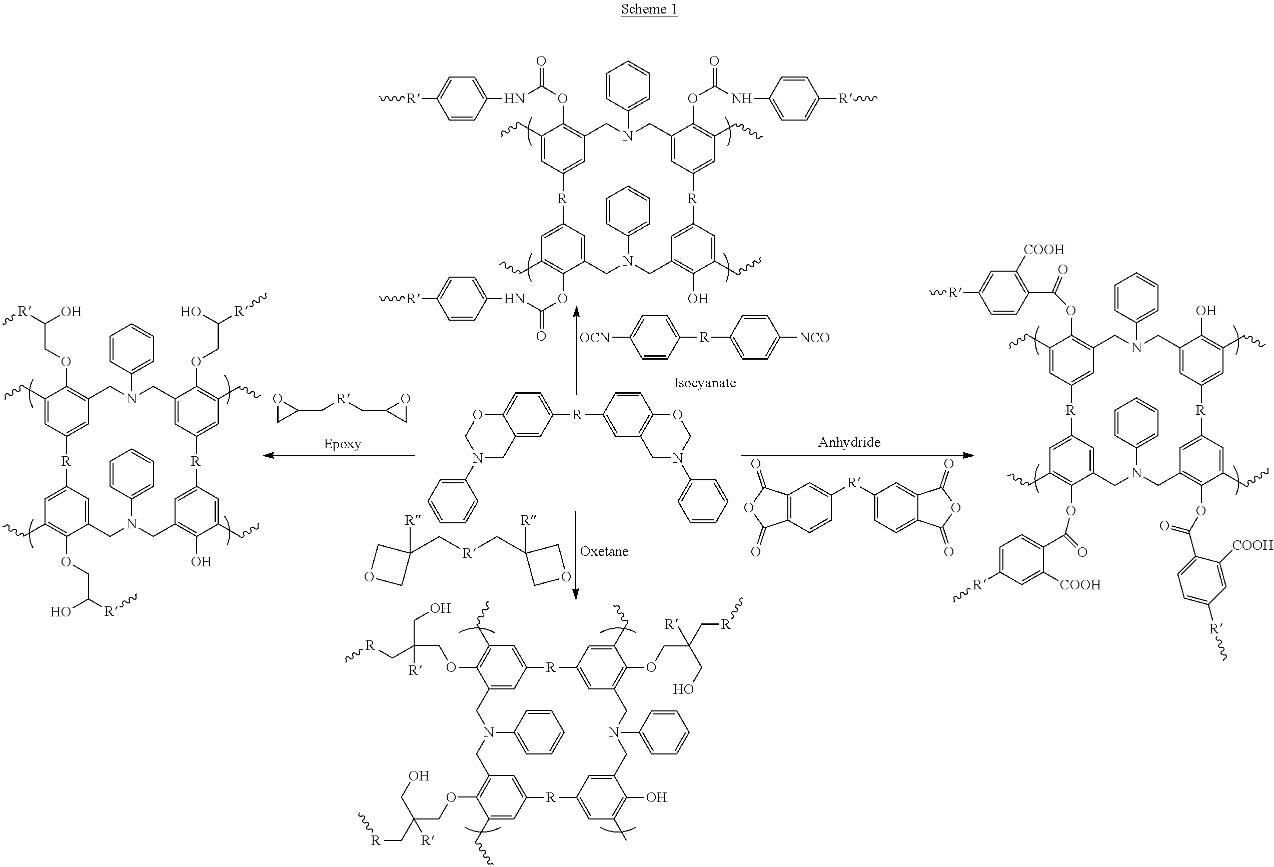

Benzoxazine-based copolymeric aerogels according to the present invention may be prepared from initial solid contents ranging from 2.5 wt % to 50 wt %, preferably from 3.0 wt % to 35 wt % and more preferably from 5 wt % to 15 wt %.

Reduction of the initial solid content on benzoxazine-based copolymeric aerogels provided reduced thermal conductivity. Additionally, in certain cases when the solid content is decreased below 10 wt %, aerogels transform from being rigid to flexible materials. For its part, by increasing the amount of initial solid content the compressive properties of aerogels may be improved (in other words, by increasing solid content, higher toughness is achieved).

A benzoxazine based copolymer aerogel according to the present invention has a benzoxazine monomer or oligomer and a comonomer weight ratio from 95% to 50% (19:1 to 1:1), based on the total monomers in the solution preferably from 90% to 65% (9:1 to 1.8:1), and more preferably from 90% to 75% (9:1 to 3:1).

Regarding benzoxazine/comonomer ratio, increasing the amount of comonomer in the formulation enhanced mechanical properties of benzoxazine based copolymer aerogels. This is likely due to the creation of more crosslinking points in the network without drastically affecting thermal conductivity. Even though an extensive crosslinking reaction added more mass to the skeletal framework of the aerogel and increased its density, the thermal conductivity slightly increased.

Benzoxazine-based copolymer aerogels according to the present invention provide a good thermal stability under air, enabling their use at higher temperatures. Moreover, aerogels according to the present invention have a glass transition temperature at around 200° C., which may extent their operation temperature range beyond typical thermal insulators, such polyurethane, elastomeric or polystyrene foams.

Suitable benzoxazine monomer for use in the present invention has a functionality from 1 to 4, preferably from 1 to 2.

Benzoxazines having functionality higher than 2 render more crosslinked aerogel structures. Benzoxazine monomer having functionality of 1 allows to form linear oligomers, which in turn form aerogels at room temperature.

Suitable benzoxazine monomer or oligomer may be a mixture of different benzoxazine monomers or oligomers with variable functionality.

Suitable benzoxazine monomer for use in the present invention is monofunctional benzoxazine having a general structure of

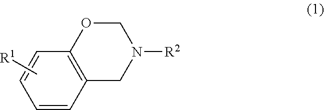

wherein R¹ is selected from the group consisting of hydrogen, halogen, alkyl and alkenyl, or R¹ is a divalent residue creating a naphthoxazine residue out of the benzoxazine structure and R² is alkyl selected from the group consisting of methyl, ethyl, propyl and butyl, alkenyl or aryl with or without substitution in one or more of the available substitutable sites;
or
bisfunctional benzoxazine having a general structure of

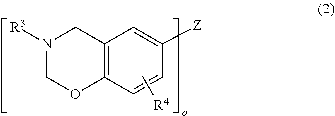

wherein o is 1 to 4, Z is selected from the group consisting of a direct bond (when o is 2), alkyl (when o is 1), alkylene (when o is 2 to 4), carbonyl (when o is 2), oxygen (when o is 2), thiol (when o is 1), sulphur (when o is 2), sulfoxide (when o is 2), and sulfone (when o is 2), each R³ is independently selected from the group consisting of hydrogen, alkyl, alkenyl or aryl, and each R⁴ is independently selected from the group consisting of hydrogen, halogen, alkyl and alkenyl or R⁴ is a divalent residue creating a naphthoxazine residue out of the benzoxazine structure;
or
bisfunctional benzoxazine having a general structure of

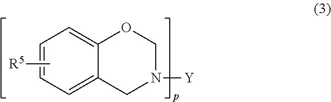

wherein p is 2, Y is selected from the group consisting of biphenyl, diphenyl methane, diphenyl isopropane, diphenyl sulphide, diphenyl sulfoxide, diphenyl sulfone, diphenyl ether, and diphenyl ketone, and R⁵ is selected from the group consisting of hydrogen, halogen, alkyl and alkenyl;
or multifunctional benzoxazine having the following general formulas:

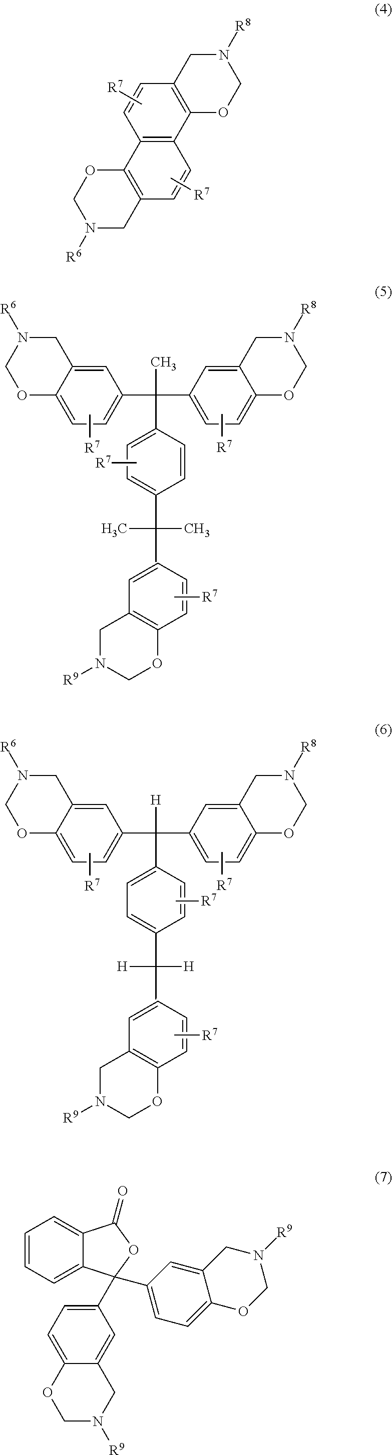

wherein R⁶, R⁸ and R⁹ are the same or different and are independently selected from the group consisting of hydrogen, alkyl, aryl, and alkenyl, R⁷ is independently selected from the group consisting of hydrogen, halogen, alkyl and alkenyl.

Preferably, benzoxazine monomer is selected from the group consisting of 4,4′-bis(3,4-dihydro-2H-1,3-benzoxazin-3-yl)phenyl methane; 6,6′-propane-2,2-diylbis(3-phenyl-3,4-dihydro-2H-1,3-benzoxazine), 6,6′-methylenebis(3-phenyl-3,4-dihydro-2H-1,3-benzoxazine, 3-phenyl-3,4-dihydro-2H-1,3-benzoxazine, 6,6′-sulfanediylbis(3-phenyl-3,4-dihydro-2H-1,3-benzoxazine), cardanol based benzoxazine, and mixtures thereof.

More preferably benzoxazine monomer is selected from the group consisting of 4′-bis(3,4-dihydro-2H-1,3-benzoxazin-3-yl)phenyl methane; 6,6′-propane-2,2-diylbis(3-phenyl-3,4-dihydro-2H-1,3-benzoxazine), 6,6′-methylenebis(3-phenyl-3,4-dihydro-2H-1,3-benzoxazine, 3-phenyl-3,4-dihydro-2H-1,3-benzoxazine and mixtures thereof.

These benzoxazine monomers are desired because they provide ideal compromise between low thermal conductivity and good mechanical properties. In addition, 3-phenyl-3,4-dihydro-2H-1,3-benzoxazine enables the formation of the aerogels at the room temperature.

Suitable benzoxazine oligomers for use in the present invention have a general structure of

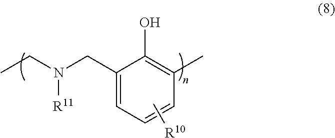

wherein R¹⁰ is selected from the group consisting of hydrogen, halogen, alkyl and alkenyl and R¹¹ is alkyl selected from the group consisting of methyl, ethyl, propyl and butyl, alkenyl; aryl with or without substitution in one or more of the available substitutable sites and n is an integer from 1 to 1000, preferably from 1 to 500, more preferably from 1 to 10 and even more preferably from 1 to 4.

Preferably, benzoxazine oligomers for use in the present invention have the following formula

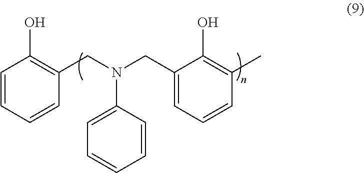

n is an integer from 1 to 1000, preferably from 1 to 500, more preferably from 1 to 10 and even more preferably from 1 to 4.

Suitable commercially available benzoxazine monomer for use in the present invention include, but not limited to 6,6′-(2,2-propanediyl)bis(3-phenyl-3,4-dihydro-2H-1,3-benzoxazine), 6,6′-sulfanediylbis(3-phenyl-3,4-dihydro-2H-1,3-benzoxazine), cardanol based benzoxazine, and 6,6′-methylenebis(3-phenyl-3,4-dihydro-2H-1,3-benzoxazine) from Huntsman, 3-phenyl-3,4-dihydro-2H-1,3-benzoxazine and 4,4′-bis(3,4-dihydro-2H-1,3-benzoxazin-3-yl)phenyl methane from Henkel.

The benzoxazine monomer is present in the reaction mixture from 1 to 48% by weight of the total reaction mixture including solvent, preferably from 3 to 15%.

If desired, benzoxazine monomers may be prepared by reacting a phenolic compound, such as mono or multifunctional phenols, with an aldehyde and alkyl or aryl amine.

A benzoxazine based copolymer aerogel according to the present invention is obtained by reacting a benzoxazine monomer or oligomer with a comonomer. In one embodiment, the comonomer is an isocyanate compound.

Suitable isocyanate compound for use in the present invention has a functionality from 1 to 6, preferably from 2 to 3.

Suitable isocyanate compound for use in the present invention is an aromatic isocyanate compound or an aliphatic isocyanate compound. Preferably said isocyanate compound is selected from the group consisting of

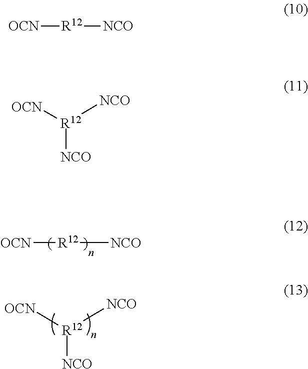

wherein R¹² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and n is an integer from 1 to 30;

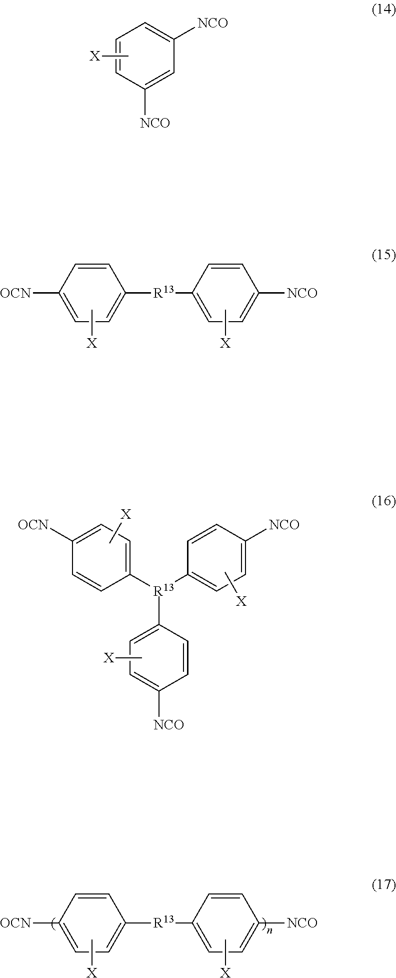

wherein X represents a substituent, or different substituents and are selected independently from the group consisting of hydrogen, halogen and linear or branched C1-C6 alkyl groups, attached on their respective phenyl ring at the 2-position, 3-position, 4-position, 5-position, 6-position and their respective isomers, and R¹³ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and n is an integer from 1 to 30.

In addition, suitable isocyanate compound for use in the present invention may be selected from the group consisting of

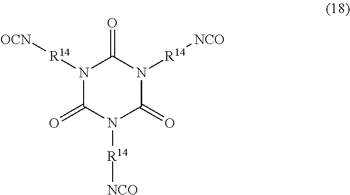

wherein R¹⁴ is alkyl group having 1-10 carbon atoms;

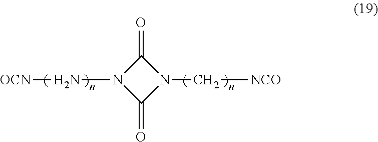

wherein n is an integer from 2 to 18;

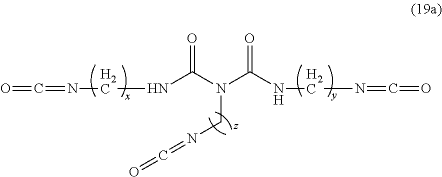

wherein x, y and z are same or different and have a value 2 to10, preferably a value 4 to 6, and more preferably x, y and z are 6;

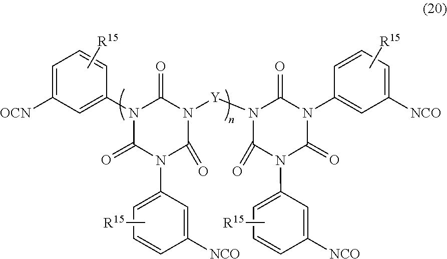

wherein R¹⁵ is selected independently from the group consisting of alkyl, hydrogen and alkenyl, and Y is selected from the group consisting of

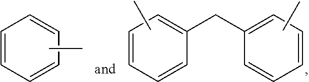

and n is an integer from 0 to 3;

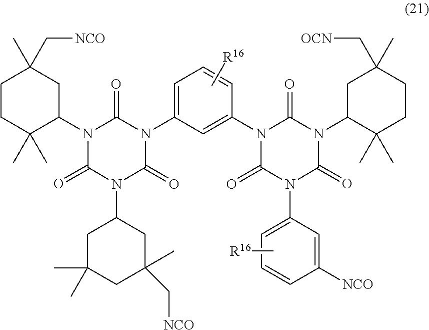

wherein R¹⁶ is selected independently from the group consisting of alkyl, hydrogen and alkenyl.

Preferably, isocyanate compound is selected from the group consisting of 1,3,5-tris(6-isocyanatohexyl)-1,3,5-triazinane-2,4,6-trione, 6-[3-(6-isocyanatohexyl)-2,4-dioxo-1,3-diazetidin-1-yl]hexyl N-(6-isocyanatohexyl)carbamate, methylene diphenyl diisocyanate (MDI) and mixtures thereof. Preferred isocyanate compounds show a good compromise between thermal conductivity and mechanical properties.

Suitable commercially available isocyanates for use in the present invention include, but not limited to Desmodur N3300, Desmodur N3200, Desmodur HL, Desmodur IL available from Bayer; Polurene KC and Polurene HR from Sapici, methylene diphenyl diisocyanate (MDI), toluylene diisocyanate (TDI) and hexamethylene diisocyanate (HDI) from Sigma Aldrich.

The isocyanate comonomer is present in the reaction mixture from 0.1 to 20% by weight of the total reaction mixture including solvent and benzoxazine monomer and/or oligomer, preferably from 0.5 to 4%.

A benzoxazine based copolymer aerogel according to the present invention has a benzoxazine monomer or oligomer and an isocyanate weight ratio from 95% to 60% (19:1 to 1.5:1) based on the total monomers in the solution, preferably from 90% to 75% (9:1 to 3:1).

A benzoxazine based copolymer aerogel according to the present invention is obtained by reacting a benzoxazine monomer or oligomer with a comonomer. In one embodiment, the comonomer is a cyclic ether compound. Preferably, the cyclic ether compound is an epoxy compound or an oxetane compound.

Suitable cyclic ether compound for use in the present invention has a functionality from 1 to 5, preferably from 3 to 5. Especially, cyclic ether compounds having functionalities 3 and 4 reacting with bisbenzoxazines provide ideal balance between low thermal conductivity and good mechanical properties. In addition, cyclic ether compounds having functionality greater than 4 reacting with monobenzoxazines provide good balance between low thermal conductivity and mechanical properties.

In one embodiment, the comonomer is an epoxy compound.

Suitable epoxy compound for use in the present invention is selected from the group consisting of

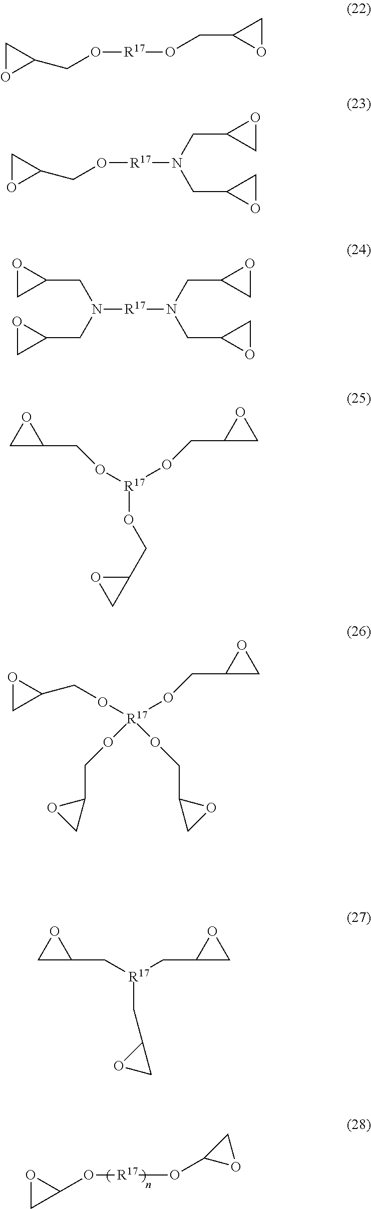

wherein R¹⁷ is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and n is an integer from 1 to 30;

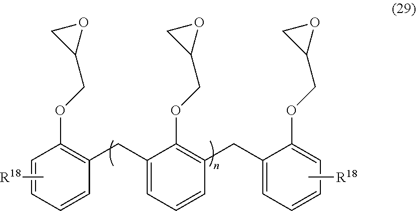

wherein R¹⁸ is selected independently from the group consisting of hydrogen, halogen, alkyl and alkenyl; and n is an integer from 1 to 10.

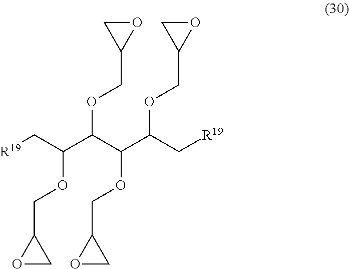

wherein R¹⁹ is selected independently from the group consisting of hydrogen, hydroxyl, halogen, alkyl and alkenyl.

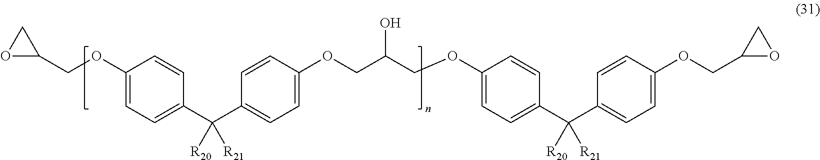

wherein R²⁰ and R²¹ are substituted or unsubstituted monovalent hydrocarbon groups or alkoxy groups and n is an integer from 0 to 16.

Preferably, the epoxy compound is selected from the group consisting of N,N-diglycidyl-4-glycidyloxyaniline, phenol novolac epoxy resins, 2-[[4-[1,2,2-tris[4-(oxiran-2-ylmethoxy)phenyl]ethyl]phenoxy]methyl]oxirane, 1,4 butanediol diglycidyl ether, cyclohexandimethanol diglycidyl ether, ethylene glycol diglycidyl ether, dipropylen glycol diglycidyl ether, 1,6 hexanediol diglycidyl ether, trimethylolpropane triglycidyl ether, polyglycerol-3-polyglycidyl ether, sorbitol glycidyl ether-aliphatic polyfunctional epoxy resin, phenol novolac epoxy resins, N,N,N′,N′-tetraglycidyl-4,4′-methylenebisbenzenamine, tris-(hydroxyl phenyl) methane-based epoxy resin, triglicidyl ether of meta-aminophenol, triglicidyl ether of para-aminophenol, bisphenol-A based epoxy resins, bisphenol-A based epoxy resins, polypropylene glycol epoxy, phenol novolac epoxy resins and mixtures thereof.

More preferably, the epoxy compound is selected from the group consisting of N,N-diglycidyl-4-glycidyloxyaniline, phenol novolac epoxy resins, and 2-[[4-[1,2,2-tris[4-(oxiran-2-ylmethoxy)phenyl]ethyl]phenoxy]methyl]oxirane and mixtures thereof.

These epoxy compounds are preferred because they provide a good compromise between thermal conductivity and mechanical properties.

Suitable commercially available epoxy compounds for use in the present invention include, but not limited to 1,4 butanediol diglycidyl ether (Erisys™ GE21), cyclohexandimethanol diglycidyl ether (Erisys™ GE22), ethylene glycol diglycidyl ether (Erisys™ EDGE), dipropylen glycol diglycidyl ether (Erisys™ GE23), 1,6 hexanediol diglycidyl ether (Erisys™ GE25), trimethylolpropane triglycidyl ether (Erisys™ GE30), polyglycerol-3-polyglycidyl ether (Erisys™ GE38), sorbitol glycidyl ether-aliphatic polyfunctional epoxy resin (Erisys™ GE60), castor oil glycidyl ether (Erisys™ GE35), (phenol novolac epoxy resins (Epalloy™ 8220, 8230, 8240, 8250, 8280, 8330, 8350, 8370), from CVC Thermoset resins; tetraglycidyl ether of 1,1,2,2-tetrakis(hydroxyphenyl)ethane (Araldite® XB-4399-3), N,N,N′,N′-Tetraglycidyl-4,4′-methylenebisbenzenamine (Araldite® MY720), tris-(hydroxyl phenyl) methane-based epoxy resin (Tactix® 742), triglicidyl ether of meta-aminophenol (Araldite® MY0610, MY0600), triglicidyl ether of para-aminophenol (Araldite® MY0510, MY0500), bisphenol-A based epoxy resins (Araldite® GY6004, GY6005, GY9513, GY9580, GY9613, GY9615, GT6243, GT4248, GT6097, GT7072, Tactix® 123) and phenol novolac epoxy resins (Araldite EPN 1179, 1180) from Huntsman; bisphenol-A based epoxy resins (D.E.R.™ 317, 330, 331, 332, 337, 362, 383) and polypropylene glycol epoxy (D.E.R.™ 732, 736), phenol novolac epoxy resins (D.E.N.™ 425, 431, 438, 439, 440) from Dow Chemical.

The epoxy comonomer is present in the reaction mixture from 0.1 to 25% by weight of the total reaction mixture including solvent and benzoxazine monomer and/or oligomer, preferably from 0.5 to 4%.

A benzoxazine based copolymer aerogel according to the present invention has a benzoxazine monomer or oligomer and an epoxy weight ratio from 95% to 50% (19:1 to 1:1) based on the total monomers in the solution preferably from 90% to 60% (9:1 to 1.5:1) and more preferably from 90% to 75% (9:1 to 3:1).

An ideal aerogel performance can be reached with a benzoxazine monomer or oligomer and an epoxy compound weight ratio is from 90% to 75% (9:1 to 3:1). This ratio provides an aerogel having low thermal conductivity and good mechanical properties

In another embodiment, the comonomer is an oxetane compound.

Suitable oxetane compound for use in the present invention is selected from the group consisting of

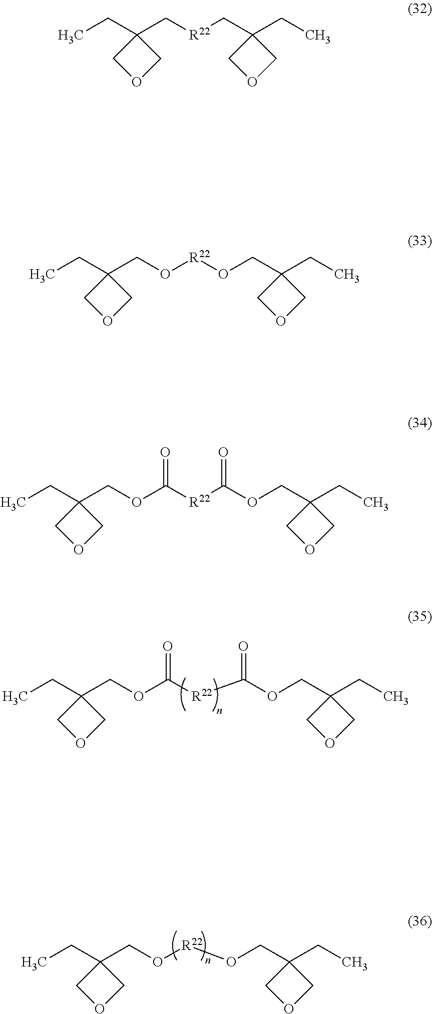

wherein R²² is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and n is an integer from 1 to 30.

Preferably, oxetane compound is selected from the group consisting of 1,4-bis[(3-ethyl-3-oxetanylmethoxy)methyl]benzene, bis[1-ethyl(3-oxetanyl)]methyl ether, bis[(3-ethyl-3-oxetanyl)methyl]terephthalate and mixtures thereof.

More preferably, oxetane compound is selected from the group consisting of 1,4-bis[(3-ethyl-3-oxetanylmethoxy)methyl]benzene and bis[1-ethyl(3-oxetanyl)]methyl ether and mixtures thereof.

These oxetane compounds are preferred because they provide a good compromise between thermal conductivity and mechanical properties.

Suitable commercially available oxetane compound for use in the present invention include, but not limited to 4,4′-bis[(3-ethyl-3-oxetanyl)methyl]biphenyl (Eternacoll OXBP), bis[(3-ethyl-3-oxetanyl)methyl]terephthalate (Eternacoll OXTP), bis[1-ethyl(3-oxetanyl)]methyl ether (Aron OXT 221), and 1,4-bis[(3-ethyl-3-oxetanylmethoxy) methyl]benzene (Aron OXT 121) from Toagosei America INC.

The oxetane comonomer is present in the reaction mixture from 0.1 to 20% by weight of the total reaction mixture including solvent and benzoxazine monomer, preferably from 0.5 to 4%.

A benzoxazine based copolymer aerogel according to the present invention has a benzoxazine monomer and an oxetane weight ratio from 95% to 60% (19:1 to 1.5:1) based on the total monomers in the solution, and more preferably from 90% to 75% (9:1 to 3:1).

Preferably, cyclic ether compound in the present invention is an epoxy compound. Epoxy compounds enable the modification of the aerogel properties to desired requirements. This is due to fact that different functional groups can be incorporated while with oxetanes are more limited. In addition, benzoxazine-epoxy copolymer aerogels are tougher than benzoxazine-oxetane copolymer aerogels for similar densities.

A benzoxazine based copolymer aerogel according to the present invention is obtained by reacting a benzoxazine monomer or oligomer with a comonomer. In one embodiment, the comonomer is an acid anhydride.

Suitable acid anhydride compounds for use in the present invention may be mono or difunctional anhydride(s)-containing compounds, derived from aliphatic or aromatic carboxylic acids. The anhydride compound reacts with the phenolic groups. In addition, use of anhydride compound has a positive effect on the blend by lowering the polymerization temperature of the blend.

Suitable acid anhydride compound has a functionality from 1 to 2.

It is believed that dianhydrides provide better thermal properties, that is, glass transition temperature and degradation temperatures.

Dianhydrides are preferred over monoanhydrides because they provide higher compressive strength values and present higher thermal stability.

Suitable acid anhydride compound is selected from the group consisting of

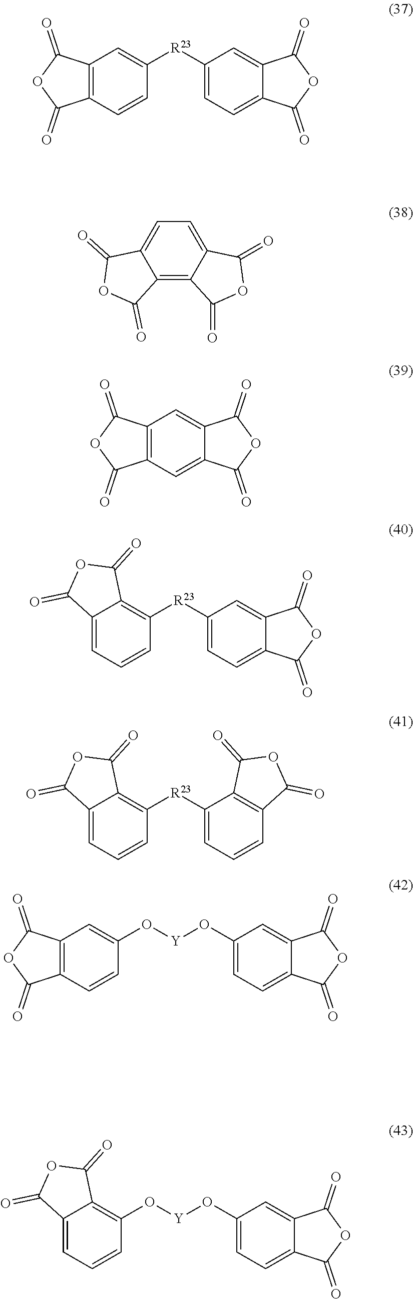

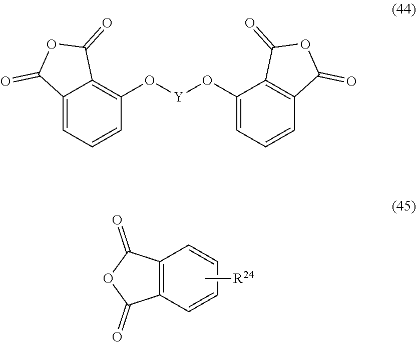

wherein R²³ is selected from the group consisting of direct bond, —CH₂—, —O—, —S—, —C(O)—, —S(O)2-, —C(CH₃)₂—, —C(CF₃)₂—, —Si(CH₃)₂— and
Y is selected from the group consisting of

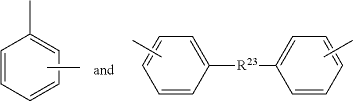

and wherein R²⁴ is selected from the group consisting of hydrogen, halogen, alkyl, alkenyl and carboxyl.

Preferably, acid anhydride compound is selected from the group consisting of benzophenonetetracarboxylic dianhydride (4,4-BTDA), trimellitic anhydride, phthalic anhydride and biphenyltetracarboxylic dianhydride (S-BDPA), 4,4′-oxydiphthalicanhydride (ODPA), 4,4′-(hexafluoroisopropylidene)diphthalic anhydride (6FDA), 4,4′-bisphenol A dianhydride (BPADA), pyromellitic dianhydride (PMDA), trimellitic anhydride (TMA), phthalic anhydride, 3,4,5,6-tetrahydrophthalic anhydride, 3,3′,4,4′-diphenylsulfonetetracarboxylic dianhydride and mixtures thereof.

More preferably, acid anhydride compound is selected from the group consisting of benzophenonetetracarboxylic dianhydride (4,4-BTDA), trimellitic anhydride, phthalic anhydride and biphenyltetracarboxylic dianhydride (S-BDPA) and mixtures thereof.

These acid anhydride compounds are preferred because they provide a good compromise between thermal conductivity and mechanical properties.

Suitable commercially available acid anhydride compound for use in the present invention but not limited to 3,3′,4,4′-biphenyltetracarboxylic dianhydride (S-BDPA), 3,3′,4,4′-benzophenone tetracarboxylic dianhydride (4,4-BTDA), 4,4′-oxydiphthalicanhydride (ODPA), 4,4′-(hexafluoroisopropylidene)diphthalic anhydride (6FDA), 4,4′-bisphenol A dianhydride (BPADA), pyromellitic dianhydride (PMDA), trimellitic anhydride (TMA), phthalic anhydride, 3,4,5,6-tetrahydrophthalic anhydride from Sigma Aldrich; and 3,3′,4,4′-diphenylsulfonetetracarboxylic dianhydride from TCI America.

The acid-anhydride comonomer is present in the reaction mixture from 0.1 to 20% by weight of the total reaction mixture including solvent and benzoxazine monomer, preferably from 0.5 to 4%.

A benzoxazine based copolymer aerogel according to the present invention has a benzoxazine monomer and an anhydride weight ratio from 95% to 60% (19:1 to 1.5:1) based on the total monomers in the solution, preferably from 90% to 75% (9:1 to 3:1).

A benzoxazine based copolymer aerogel according to the present invention is formed in the presence of a solvent.

Suitable solvent for use in the present invention is a polar solvent, preferably polar aprotic solvent with high dielectric constant. Solvents with high dielectric constants are preferred because they favour oxazine ring opening.

More preferably, solvent is selected from the group consisting of dimethylsulfoxide, dimethylformamide, dimethylacetamide, N-methyl-2-pyrrolidone, 1,4-dioxane and mixtures thereof, and more preferably said solvent is selected from the group consisting of dimethylsulfoxide, dimethylacetamide and mixtures thereof.

A benzoxazine based copolymer aerogel according to the present invention is obtained in the presence of a catalyst. With the exception of the comonomer, being an acid anhydride compound or an isocyanate, then the catalyst is an optional ingredient. The presence of a catalyst accelerates oxazine ring-opening and/or copolymerization reaction.

Suitable catalysts for use in the present invention include phenolic compounds, carboxylic acids, acetylacetonate complexes, Lewis acids, secondary and tertiary amines, quaternary onium salts, metal halides, organometallic derivatives, metallophrophyrine compounds, and mixtures thereof.

Preferably, the catalyst is selected from the group consisting of iron (III) acetylacetonate, lithium iodide, cobalt (II) acetylacetonate and cobalt (III) acetylacetonate for copoly(anhydride-benzoxazine) aerogels; tetraphenylphosphonium iodide and tetrabutylammonium tetrafluoroborate for copoly(oxetane-benzoxazine) aerogels; N,N-dimethylbenzylamine and 1,5,7-triazabicyclodec-5-ene for copoly(urethane/urea-benzoxazine) aerogels; and thiodiphenolic acid for copoly(epoxy-benzoxazine) aerogels.

Suitable commercially available catalysts for use in the present invention are but not limited to acetylacetonate, cobalt (II) acetylacetonate and cobalt (III) acetylacetonate, itaconic acid, lithium iodide, zinc trifluoromethanesulfonate, iron (III) chloride, lithium perchlorate, lithium thiocyanate tetraphenylphosphonium chloride, tetraphenylphosphonium iodide, tetraphenylphosphonium bromide, tetrabutylammonium hexafluorophosphate, tetrabutylammonium tetrafluoroborate, N,N-dimethylbenzylamine (DMBA), dibutyltin dilaurate (DBDTL), 1,4-diazabicyclo[2.2.2]octane (DABCO), 1,8-diazabicycloundec-7-ene (DBU), thiodiphenolic acid, thiopropionic acid, p-toluenesulfonic acid, 2-ethyl-4-methylimidazole.

A benzoxazine based copolymer aerogel according to the present invention comprises a catalyst, when present, from 2 to 40% by weight of the total weight of the aerogel, preferably from 3 to 20% and more preferably from 5 to 10%.

A benzoxazine based copolymer aerogel according to the present invention has preferably a thermal conductivity less than 55 mW/m·K, more preferably less than 50 mW/m·K, and even more preferably less than 45 mW/m·K. Thermal conductivity can be measured by using diffusivity sensor method or steady-state condition system method as described below.

### Diffusivity Sensor Method

In this method, the thermal conductivity is measured by using a diffusivity sensor. In this method, the heat source and the measuring sensor are on the same side of the device. The sensors measure the heat that diffuses from the sensor throughout the materials. This method is appropriate for lab scale tests.

### Steady-State Condition System Method

In this method, the thermal conductivity is measured by using a steady-state condition system. In this method, the sample is sandwiched between a heat source and a heat sink. The temperature is risen on one side, the heat flows through the material and once the temperature on the other side is constant, both heat flux and difference of temperatures are known, and thermal conductivity can be measured.

In order to have a good performance of insulating material it is very important to have as low thermal conductive value as possible and good mechanical performance. Introducing a comonomer in the structure, the mechanical properties are increasing, while thermal conductivity remains almost the same.

A benzoxazine based copolymer aerogel according to the present invention has preferably a compressive Young's modulus more than 0.2 MPa, more preferably more than 15 MPa, and even more preferably more than 30 MPa. Compression Young Modulus is measured with Instron 3366 according to the standard ASTM D1621.

benzoxazine based copolymer aerogel according to the present invention has preferably a compressive strength more than 0.1 MPa, more preferably more than 0.45 MPa, and even more preferably more than 3 MPa. Compressive strength is measured according to the standard ASTM D1621.

A benzoxazine based copolymer aerogel according to the present invention has a specific surface area ranging from 33 m²/g to 134 m²/g. Surface area is determined from N₂ sorption analysis at −196° C. using the Brunauer-Emmett-Teller (BET) method, in a specific surface analyzer, ASAP 2020 (Micromeritics Instruments). High surface area values are preferred because this means small pore sizes and, therefore, obtained aerogels have low thermal conductivity values.

Benzoxazine based copolymer aerogel according to the present invention has a pore size ranging from 5 to 50 nm. In certain embodiments benzoxazine based copolymer aerogel has an average pore size ranging about 8.6 nm to 12.4 nm. Pore size distribution is calculated from Barret-Joyner-Halenda (BJH) model applied to the desorption branch from the isotherms measured by N₂ sorption analysis. Average pore size was determined by applying the following equation: Average pore size=(4*V/SA) wherein V is total pore volume and SA is surface area calculated from BET.

Aerogel pore size below mean free path of air (which is 70 nm) is desired, because that allows obtaining high performance thermal insulation aerogels having very low thermal conductivity values.

Benzoxazine based copolymer aerogel according to the present invention can be produced by a process comprising the steps of:

1) dissolving a benzoxazine monomer or oligomer, comonomer and a catalyst (if required) into a solvent and mixing,

2) transferring the mixture of step 1) to a sealed mould;

3) heating the solution in order to form a gel;

4) washing said gel with a solvent;

5) drying said gel by supercritical or ambient drying; and

6) postcuring of the obtained aerogel by thermal treatment.

The reaction mixture is prepared in a closed container.

Gelation step (3) is carried out in the oven for the pre-set time and temperature. Preferably, temperature is applied on step 3, more preferably, temperature from room temperature to 160° C. is applied while gel is, forming. Even more preferably, temperature from 100 to 150° C. is applied, and most preferably, temperature from 130° C. to 150° C. is applied.

Temperatures from room temperature to 160° C. are preferred because of higher temperatures than 160° C. require the use of solvents with extremely high boiling points.

Gelation time is preferably from 0.5 to 120 hours, preferably from 5 to 72 hours and more preferably from 24 to 45 hours.

Washing time is preferably from 24 hours to 96 hours, preferably from 24 hours to 72 hours.

The solvent of wet gels of step 3) is changed one or more times after the gelation. The washing steps are done gradually, and if required, to the preferred solvent for the drying process. Once the wet gel remains in the proper solvent, it is dried in supercritical (CO₂) or ambient conditions obtaining aerogel material.

In one embodiment, the washing steps are done gradually as follows: 1) DMSO; 2) DMSO/acetone 1:1; and 3) acetone.

In another embodiment, the washing steps are done gradually as follows: 1) DMSO; 2) DMSO/acetone 1:1; 3) acetone; 4) acetone/hexane 3:1; 5) acetone/hexane 1:1; 6) acetone/hexane 1:3 and 7) hexane.

Once the solvent has been completely replaced by acetone or hexane, gel is dried in supercritical (CO₂) or ambient conditions, respectively, obtaining aerogel material. When the replacing solvent is acetone, the obtained gels are dried in CO₂, whereas the replacing solvent is hexane, the obtained gels are dried in ambient conditions.

The supercritical state of a substance is reached once its liquid and gaseous phases become indistinguishable. The pressure and temperature at which the substance enters this phase is called critical point. In this phase, the fluid presents the low viscosity of a gas, maintaining the higher density of a liquid. It can effuse through solids like a gas and dissolve materials like a liquid. Considering an aerogel, once the liquid inside the wet gel pores reaches the supercritical phase, its molecules do not possess enough intermolecular forces to create the necessary surface tension that creates capillarity stress. Hence, the gel can be dried, minimizing shrinkage and possible collapse of the gel network.

The drying process at supercritical conditions is performed by exchanging the solvent in the gel with CO₂ or other suitable solvents in their supercritical state. Due to this, capillary forces exerted by the solvent during evaporation in the nanometric pores are minimized and shrinkage of the gel body can be reduced.

In one embodiment, the method for preparing the organic aerogel involves the recycling of the CO₂ from the supercritical drying step.

Alternatively, wet gels can be dried at ambient conditions, in which the solvent is evaporated at room temperature. However, as the liquid evaporates from the pores, it can create a meniscus that recedes back into the gel due to the difference between interfacial energies. This may create a capillary stress on the gel, which responds by shrinking. If these forces are strong enough, they can even lead to the collapse or cracking of the whole structure. However, there are different possibilities to minimize this phenomenon. One practical solution involves the use of solvents with low surface tension to minimize the interfacial energy between the liquid and the pore. Hexane is usually used as a convenient solvent for ambient drying, as its surface tension is one of the lowest among the conventional solvents. Unfortunately, not all the solvents lead to gelation, which means that some cases would require the exchange of solvent between an initial one required for the gel formation and a second one most appropriate for the drying process.

The organic aerogels according to the present invention can be reinforced by suitable fibre or filler compositions (either natural or synthetic), which may be based on organic, inorganic or both compounds.

Preferably, temperature from 150° C. to 220° C. is applied at step 6 to post-cure an aerogel, more preferably, temperature from 160° C. to 200° C., and most preferably temperature from 160° C. to 180° C. is applied.

The present invention also relates to a thermal insulating material or an acoustic material comprising a benzoxazine based copolymer aerogels according to the present invention.

Benzoxazine based copolymer aerogels according to the present invention can be used as a thermal insulating material or acoustic material.

Aerogels may be used in a variety of applications such as building construction, electronics or for the aerospace industry. Aerogel could be used as thermal insulating material for refrigerators, freezers, automotive engines and electronic devices. Another potential applications for aerogels is as a sound absorption material and a catalyst support.

Organic aerogels according to the present invention can be used for thermal insulation in different applications such as aircrafts, space crafts, pipelines, tankers and maritime ships replacing currently used foam panels and other foam products, in car battery housings and under hood liners, lamps, in cold packaging technology including tanks and boxes, jackets and footwear and tents.

Organic aerogels according to the present invention can also be used in construction materials due to their lightweight, strength, ability to be formed into desired shapes and superior thermal insulation properties.

Organic aerogels according to the present invention can be also used for storage of cryogens.

Organic aerogels according to the present invention can be also used as an adsorption agent for oil spill clean-up, due to their high oil absorption rate.

Organic aerogels according to the present invention can be also used in safety and protective equipment as a shock-absorbing medium.

### EXAMPLES

### Example 1

Polybenzoxazine-anhydride aerogels: with or without catalyst

Polybenzoxazine-anhydride aerogels were prepared using 6,6′-(2,2-propanediyl)bis(3-phenyl-3,4-dihydro-2H-1,3-benzoxazine) (Ba-Bz) from Huntsman, and benzophenonetetracarboxylic dianhydride (4,4-BTDA) from Sigma Aldrich.

Solutions were prepared with a total solid content of approximately 10 wt % from two solutions. For the first solution Ba-Bz (1.10 g, 2.4 mmol) and 4,4-BTDA (0.12 g, 0.38 mmol) were dissolved in 5 mL of dimethylsulfoxide (DMSO).

Benzoxazine/anhydride weight ratio of the mixture was 9:1 (90:10 wt %). The second solution was prepared dissolving Iron (III) acetylacetonate (0.084 g, 0.24 mmol) in 5 mL of DMSO. Both solutions were mixed, transferred to a sealed mold and heated up at 130° C. (62 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

An aerogel was also prepared using the above described methodology without a catalyst.

For the comparison, homopolybenzoxazine aerogels as blank were prepared as above described without the comonomer 4,4-BTDA.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.14 | 0.036 | 1.2 | 0.16 |
| polybenzoxazine | | | | |
| Polybenzoxazine- | 0.17 | 0.038 | 2.1 | 0.25 |
| anhydride | | | | |
| Polybenzoxazine- | 0.19 | 0.040 | 4.1 | 0.41 |
| anhydride | | | | |
| (without catalyst) | | | | |

### Example 2

An aerogel was also prepared using the above described methodology except 3,3′,4,4′-biphenyltetracarboxylic dianhydride (S-BDPA) was used as dianhydride from SigmaAldrich and 4,4′-bis(3,4-dihydro-2H-1,3-benzoxazin-3-yl)phenyl methane (PdBz) as bisbenzoxazine from Henkel and without adding a catalyst.

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.12 | 0.039 | 1.4 | 0.16 |
| polybenzoxazine | | | | |
| Polybenzoxazine- | 0.18 | 0.038 | 4.2 | 0.38 |
| anhydride | | | | |
| (without catalyst) | | | | |

### Example 3

Polybenzoxazine-epoxy aerogels. Bisbenzoxazine

Polybenzoxazine-epoxy aerogels were prepared using 6,6′-(2,2-Propanediyl)bis(3-phenyl-3,4-dihydro-2H-1,3-benzoxazine) (Ba-Bz) and tetraglycidyl ether of 1,1,2,2-tetrakis(hydroxyphenyl)ethane (XB-4399-3) from Huntsman.

Solutions were prepared with a total solid content of approximately 10 wt % from two solutions. For the first solution Ba-Bz (1.10 g, 2.4 mmol) and XB-4399-3 (0.12 g, 0.20 mmol) were dissolved in 5 mL of dimethylsulfoxide (DMSO).

Benzoxazine/epoxy weight ratio of the mixture was 9:1 (90:10 wt %). The second solution was prepared dissolving 4,4′-thiodiphenol (0.12 g, 0.56 mmol) in 5 mL of DMSO. Both solutions were mixed, transferred to a sealed mold and heated up at 130° C. (100 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

For the comparison, homopolybenzoxazine aerogels were prepared as blank without the epoxy resin comonomer XB-4399-3.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.19 | 0.042 | 5.0 | 0.46 |
| polybenzoxazine | | | | |
| Polybenzoxazine- | 0.21 | 0.045 | 13.6 | 0.42 |
| epoxy | | | | |

### Example 4

Polybenzoxazine-epoxy aerogels. Monobenzoxazine

Polybenzoxazine-epoxy aerogels were prepared using 3-phenyl-3,4-dihydro-2H-1,3-benzoxazine (Pa-Bz) and Sorbitol Glycidyl ether-aliphatic polyfunctional epoxy resin (Erysis GE60) from CVC Thermoset resins.

Solutions were prepared with a total solid content of approximately 10 wt % from two solutions. For the first solution Pa-Bz (0.92 g, 4.3 mmol) and Erysis GE60 (0.31 g, 0.65 mol) were dissolved in 5 mL of dimethylsulfoxide (DMSO). Benzoxazine/epoxy weight ratio of the mixture was 3:1 (75:25 wt %). The second solution was prepared dissolving 4,4′-thiodiphenol (0.12 g, 0.56 mmol) in 5 mL of DMSO. Both solutions were mixed, transferred to a sealed mold and heated up at 130° C. (222 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

Thermal conductivity was measured with a heat diffusivity sensor (C-Therm TCi) according to the test method described in the description.

Compression Young Modulus was measured with an Instron 3366 (ASTM D1621).

| | Bz/ | | | Com- | Com- |
|---|---|---|---|---|---|
| | epoxy | | Thermal | pressive | pressive |
| | ratio | Density | conductivity | modulus | strength |
| Aerogel | (wt %) | (g/cm³) | (W/m · K) | (MPa) | (MPa) |
| Polybenzoxazine- | 75:25 | 0.33 | 0.047 | 32.4 | 3.2 |
| epoxy | | | | | |

### Example 5

Polybenzoxazine-epoxy aerogels. Varying the initial solid content.

Polybenzoxazine-epoxy aerogels were prepared using 4,4′-bis(3,4-dihydro-2H-1,3-benzoxazin-3-yl)phenyl methane (Pd-Bz) from Henkel and N,N-diglycidyl-4-glycidyloxyaniline (Araldite MY0510) from Huntsman.

Solutions were prepared varying the total solid content. Thus, as an illustrative example, solutions having 7.5 wt % total solid content were prepared dissolving Pd-Bz (0.80 g, 1.9 mmol) and Araldite MY0510 (0.09 g, 0.32 mmol) in 5 mL of dimethylsulfoxide (DMSO). Benzoxazine/epoxy weight ratio of the mixture was 9:1 (90:10 wt %). A second solution was prepared dissolving 4,4′-thiodiphenol (0.09 g, 0.14 mmol) in 5 mL of DMSO. Both solutions were mixed, transferred to a sealed mold and heated up at 130° C. (72 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

For the comparison, homopolybenzoxazine aerogels were prepared as blank without the epoxy resin comonomer Araldite MY0510.

Thermal conductivity was measured with a heat diffusivity sensor (C-Therm TCi) according to the test method described in the description.

Compression Young Modulus was measured with an Instron 3366 (ASTM D1621).

| | | | | Com- | Com- |
|---|---|---|---|---|---|
| | Solid | | Thermal | pressive | pressive |
| | content | Density | conductivity | modulus | strength |
| Aerogel | (wt %) | (g/cm³) | (W/m · K) | (MPa) | (MPa) |
| Homo- | 5.0 | 0.08 | 0.034 | 0.1 | 0.02 |
| polybenzoxazine | | | | | |
| Polybenzoxazine- | 5.0 | 0.07 | 0.034 | 0.2 | 0.10 |
| epoxy | | | | | |
| Homo- | 7.5 | 0.12 | 0.038 | 0.6 | 0.19 |
| polybenzoxazine | | | | | |
| Polybenzoxazine- | 7.5 | 0.16 | 0.037 | 1.0 | 0.21 |
| epoxy | | | | | |
| Homo- | 10 | 0.12 | 0.039 | 1.4 | 0.16 |
| polybenzoxazine | | | | | |
| Polybenzoxazine- | 10 | 0.16 | 0.041 | 3.5 | 0.30 |
| epoxy | | | | | |

Increasing solid content of polybenzoxazine-epoxy aerogels increases mechanical properties and thermal conductivity.

### Example 6

Polybenzoxazine-epoxy aerogels. Varying the comonomer amount.

Polybenzoxazine-epoxy aerogels were prepared using 6,6′-methylenebis(3-phenyl-3,4-dihydro-2H-1,3-benzoxazine) (Bf-Bz) from Huntsman and polypropylene glycol epoxy (D.E.R. 736) from Dow chemicals.

Solutions were prepared with a total solid content of approximately 10 wt % varying benzoxazine/epoxy weight ratios. Thus, as an illustrative example, solutions having a benzoxazine/epoxy ratio of 3:1 (75:25 wt %) was prepared dissolving Bf-Bz (0.92 g, 2.1 mmol) and D.E.R. 736 (0.31 g) in 5 mL of dimethyl-sulfoxide (DMSO). A second solution was prepared dissolving 4,4′-thiodiphenol (0.12 g, 0.56 mmol) in 5 mL of DMSO. Both solutions were mixed, transferred to a sealed mold and heated up at 130° C. (72 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

For the comparison, homopolybenzoxazine were prepared as blank without the epoxy resin comonomer, D.E.R.736.

Thermal conductivity was measured with a heat diffusivity sensor (C-Therm TCi) according to the test method described in the description.

Compression Young Modulus was measured with an lnstron 3366 (ASTM D1621).

| | Bz/ | | | Com- | Com- |
|---|---|---|---|---|---|
| | epoxy | | Thermal | pressive | pressive |
| | ratio | Density | conductivity | modulus | strength |
| Aerogel | (wt %) | (g/cm³) | (W/m · K) | (MPa) | (MPa) |
| Homo- | 100:0 | 0.13 | 0.040 | 3.7 | 0.26 |
| polybenzoxazine | | | | | |
| Polybenzoxazine- | 90:10 | 0.16 | 0.042 | 7.8 | 0.73 |
| epoxy | | | | | |
| Polybenzoxazine- | 75:25 | 0.25 | 0.044 | 8.6 | 0.69 |
| epoxy | | | | | |

Mechanical properties of polybenzoxazine-epoxy aerogel may improve increasing the epoxy amount.

### Example 7

Polybenzoxazine-urethane/urea aerogels: with or without catalyst

Polybenzoxazine-urethane/urea aerogels were prepared using 4,4′-bis(3,4-dihydro-2H-1,3-benzoxazin-3-yl)phenyl methane (Pd-Bz) from Henkel and Desmodur N3200 from Bayer Corporation.

Solutions were prepared with a total solid content of approximately 10 wt % from two solutions. For the first solution Pd-Bz (0.55 g, 1.3 mmol) and Desmodur N3200 (0.06 g) were dissolved in 3 mL of dimethylsulfoxide (DMSO). Benzoxazine/isocyanate weight ratio of the mixture was 9:1 (90:10 wt %). The second solution was prepared dissolving N,N-dimethylbenzylamine (0.006 g, 0.05 mmol) in 2 mL of DMSO. Both solutions were mixed, transferred to a sealed mold and heated up at 130° C. (48 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

An aerogel was also prepared using the above described methodology without adding a catalyst.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.12 | 0.039 | 1.4 | 0.16 |
| polybenzoxazine | | | | |
| Polybenzoxazine- | 0.17 | 0.039 | 3.7 | 0.36 |
| urethane/urea | | | | |
| Polybenzoxazine- | 0.18 | 0.040 | 4.9 | 0.29 |
| urethane/urea | | | | |
| (without catalyst) | | | | |

### Example 8

Polybenzoxazine-urethane/urea aerogels using tetrafunctional isocyanate

Polybenzoxazine-urethane aerogels were prepared using 4,4′-bis(3,4-dihydro-2H-1,3-benzoxazin-3-yl)phenyl methane (Pd-Bz) from Henkel and Desmodur HL from Bayer Corporation.

Solution was prepared with a total solid content of approximately 10 wt %. Pd-Bz (4 g, 9.2 mmol), Desmodur HL (0.44 g, containing 0.26 g of pure HL in butyl acetate, 0.3 mmol) and DMBA (0.02 g 0.14 mmol) were dissolved in 20 mL of dimethylsulfoxide (DMSO). Benzoxazine/isocyanate weight ratio of the mixture was 9:1 (90:10 wt %). The solution was mixed, transferred to a sealed mold and heated up at 130° C. (72 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.12 | 0.039 | 1.4 | 0.16 |
| polybenzoxazine | | | | |
| Polybenzoxazine- | 0.18 | 0.041 | 5.3 | 0.40 |
| urethane/urea | | | | |

### Example 9

Polybenzoxazine-urethane/urea aerogels using hexafunctional isocyanate

Polybenzoxazine-urethane/urea aerogels were prepared using 4,4′-bis(3,4-dihydro-2H-1,3-benzoxazin-3-yl)phenyl methane (Pd-Bz) from Henkel and Polurene KC from Sapici Corporation.

Solution was prepared with a total solid content of approximately 10 wt %. Pd-Bz (4 g, 9.2 mmol), Polurene KC (0.44 g, containing 0.22 g of pure KC in butyl acetate, 0.14 mmol) and DMBA (0.02 g, 0.14 mmol) were dissolved in 20 mL of dimethylsulfoxide (DMSO). Benzoxazine/isocyanate weight ratio of the mixture was 9:1 (90:10 wt %). The solution was mixed, transferred to a sealed mold and heated up at 130° C. (72 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.12 | 0.039 | 1.4 | 0.16 |
| polybenzoxazine | | | | |
| Polybenzoxazine- | 0.18 | 0.041 | 3.6 | 0.28 |
| urethane/urea | | | | |

### Example 10

Polybenzoxazine-urethane/urea aerogels using difunctional isocyanate

Polybenzoxazine-urethane/urea aerogels were prepared using 6,6′-methylenebis(3-phenyl-3,4-dihydro-2H-1,3-benzoxazine (Bf-Bz) from Henkel and diphenylmethane 4,4′-diisocyanate (MDI) from Merck Corporation.

Solution was prepared with a total solid content of approximately 10 wt %. Bf-Bz (4.4 g, 1.0 mmol), MDI (0.49 g, 1.9 mmol) and DMBA (0.05 g 0.4 mmol) were dissolved in 20 mL of dimethylsulfoxide (DMSO). Benzoxazine/isocyanate weight ratio of the mixture was 9:1 (90:10 wt %). The solution was mixed, transferred to a sealed mold and heated up at 130° C. (48 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.13 | 0.040 | 3.7 | 0.26 |
| polybenzoxazine | | | | |
| Polybenzoxazine- | 0.15 | 0.041 | 4.5 | 0.37 |
| urethane/urea | | | | |

### Example 11

Polybenzoxazine-urea/urethane from oligomers at room temperatura

Polybenzoxazine-urea/urethane aerogels were prepared using 3-phenyl-3,4-dihydro-2H-1,3-benzoxazine (Pa-Bz) from Henkel and Desmodur RE from Bayer Corporation.

Benzoxazine oligomers were prepared by heating 20 g of PaBz at 180° C. In order to obtain different molecular weights the reaction time was varied.

Solutions were prepared having a total solid content of 7 wt %, and a benzoxazine oligomers/isocyanate weight ratio of 2.3:1 (70:30 wt %). 0.9 g of Pa-Bz oligomers were dissolved in 18.2 mL of N,N-Dimethylacetamide (DMAc). Subsequently 1.43 g of Desmodur RE (27% pure isocyanate in ethyl acetate) were added and then stirred. Finally 0.044 g of dibutyltin dilaurate (DBTDL) were added while continuing stirring. The final solution was transferred to a sealed mold and left up to gelation at room temperature and subsequently the gel was aged for 48 h at room temperature. Prior to drying, the resulting wet-gel was washed stepwise in a mixture of DMAc:Acetone (3:1), DMAc:Acetone (1:1), DMAc:Acetone (1:3) and acetone, during 24 h for each step, and using three times the volume of the gel. Finally, the wet-gel was dried into aerogels with supercritical CO₂

Thermal conductivity was measured with a heat diffusivity sensor (C-Therm TCi) according to the test method described in the description.

Compression Young Modulus was measured with an Instron 3366 (ASTM D1621).

The molecular weight of oligomers was determined by gel permeation chromatography (GPC) analysis. The analysis was conducted using an Agilent 1260 Infinity equipped with a guard column before two analytical columns: PL Mixed gel C 5 μm, and PL gel 5 μm, 104 Å. The mobile phase was tetrahydrofuran (THF). A refractive index detector with molecular weight calibration using poly(methyl methacrylate) standard was used. The GPC temperature was 40° C.

| | Oligomer | | | Com- | Com- |
|---|---|---|---|---|---|
| | molecular | | Thermal | pressive | pressive |
| | weight | Density | conductivity | modulus | strength |
| Aerogel | (g/mol) | (g/cm³) | (W/m · K) | (MPa) | (MPa) |
| Polybenzoxazine- | 423 | 0.29 | 0.045 | 28.9 | 2.6 |
| isocyanate-MW1 | | | | | |
| Polybenzoxazine- | 833 | 0.33 | 0.050 | 45.1 | 4.1 |
| isocyanate-MW2 | | | | | |

### Example 12

Polybenzoxazine-oxetane aerogels

Polybenzoxazine-oxetane aerogels were prepared using 4,4′-bis(3,4-dihydro-2H-1,3-benzoxazin-3-yl)phenyl methane (Pd-Bz) from Henkel and 4,4′-bis[(3-ethyl-3-oxetanyl)methyl]biphenyl (OXBP) from Toagosei America INC.

Solutions were prepared with a total solid content of approximately 10 wt % from two solutions. For the first solution Pd-Bz (0.55 g, 1.3 mmol) and OXBP (0.06 g) were dissolved in 3 mL of dimethylsulfoxide (DMSO). Benzoxazine/oxetane weight ratio of the mixture was 9:1 (90:10 wt %). The second solution was prepared dissolving tetraphenylphosponium iodide (TPPI) (0.027 g, 0.06 mmol) in 2 mL of DMSO. Both solutions were mixed, transferred to a sealed mold and heated up at 130° C. (48 h) and 150° C. (5 h). Gel was stepwise washed with DMSO (2×), DMSO:acetone (1:1, 2×) and with acetone (6×), during 12 h for each step, and using three times the volume of the gel. Finally, the wet-gel was dried into aerogels with supercritical CO₂. Subsequently, the material was step-cured at 160° C. (1 h) and 180° C. (3 h) using a convection oven.

Thermal conductivity was measured with a heat diffusivity sensor (C-Therm TCi) according to the test method described in the description.

Compression Young Modulus was measured with an Instron 3366 (ASTM D1621).

| | | Thermal | Compressive | Compressive |
|---|---|---|---|---|
| | Density | conductivity | modulus | strength |
| Aerogel | (g/cm³) | (W/m · K) | (MPa) | (MPa) |
| Homo- | 0.12 | 0.039 | 1.4 | 0.16 |
| polybenzoxazine | | | | |
| Polybenzoxazine- | 0.14 | 0.039 | 1.9 | 0.22 |
| oxetane | | | | |

What is claimed is:

1. A benzoxazine based copolymer aerogel obtained by reacting a benzoxazine monomer or oligomer and a comonomer selected from the group consisting of an isocyanate compound, a cyclic ether compound and an acid anhydride compound in a presence of a catalyst and a solvent, wherein said catalyst is an optional ingredient when said comonomer is an acid anhydride or an isocyanate compound.

2. A benzoxazine based copolymer aerogel according to claim 1, wherein said benzoxazine monomer has a functionality from 1 to 4, and said isocyanate compound has a functionality from 1 to 6, or said cyclic ether compound has a functionality from 1 to 5, or said acid anhydride compound has a functionality from 1 to 2.

3. A benzoxazine based copolymer aerogel according to claim 1, wherein said benzoxazine monomer or oligomer is monofunctional benzoxazine having a general structure of 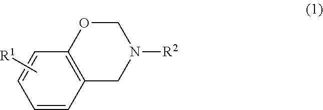
wherein R¹ is selected from the group consisting of hydrogen, halogen, alkyl and alkenyl, or R¹ is a divalent residue creating a naphthoxazine residue out of the benzoxazine structure and R² is alkyl selected from the group consisting of methyl, ethyl, propyl and butyl, alkenyl or aryl with or without substitution in one or more of the available substitutable sites;
or
bisfunctional benzoxazine having a general structure of 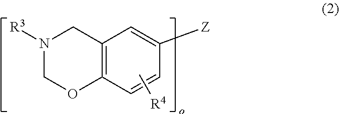
wherein o is 1 to 4, Z is selected from the group consisting of a direct bond (when o is 2), alkyl (when o is 1), alkylene (when o is 2 to 4), carbonyl (when o is 2), oxygen (when o is 2), thiol (when o is 1), sulphur (when o is 2), sulfoxide (when o is 2), and sulfone (when o is 2), each R³ is independently selected from the group consisting of hydrogen, alkyl, alkenyl or aryl, and each R⁴ is independently selected from the group consisting of hydrogen, halogen, alkyl and alkenyl or R⁴ is a divalent residue creating a naphthoxazine residue out of the benzoxazine structure;
or bisfunctional benzoxazine having a general structure of 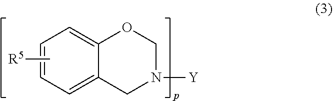
wherein p is 2, Y is selected from the group consisting of biphenyl, diphenyl methane, diphenyl isopropane, diphenyl sulphide, diphenyl sulfoxide, diphenyl sulfone, diphenyl ether, and diphenyl ketone, and R⁵ is selected from the group consisting of hydrogen, halogen, alkyl and alkenyl;
or multifunctional benzoxazine having the following general formulas: 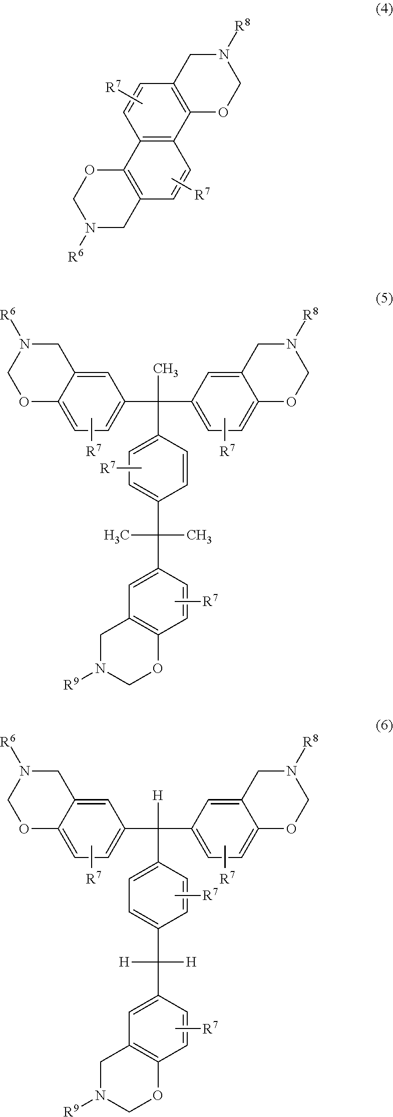 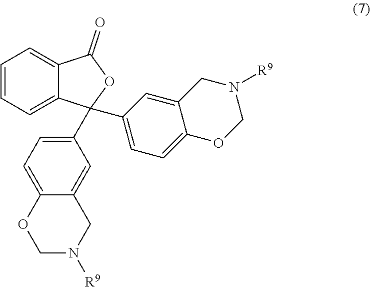
wherein R⁶, R⁸ and R⁹ are the same or different and are independently selected from the group consisting of hydrogen, alkyl, aryl, and alkenyl, R⁷ is independently selected from the group consisting of hydrogen, halogen, alkyl and alkenyl;
or
benzoxazine oligomer having a general structure of 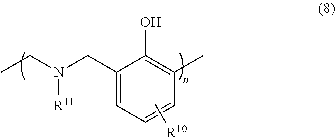
wherein R¹⁰ is selected from the group consisting of hydrogen, halogen, alkyl and alkenyl and R¹¹ is alkyl selected from the group consisting of methyl, ethyl, propyl and butyl, alkenyl, aryl with or without substitution in one or more of the available substitutable sites, and wherein n is an integer from 1 to 1000.

4. A benzoxazine based copolymer aerogel according to claim 1, wherein said isocyanate compound is an aromatic isocyanate compound or an aliphatic isocyanate compound,

5. A benzoxazine based copolymer aerogel according to claim 1, wherein said isocyanate compound is selected from the group consisting of 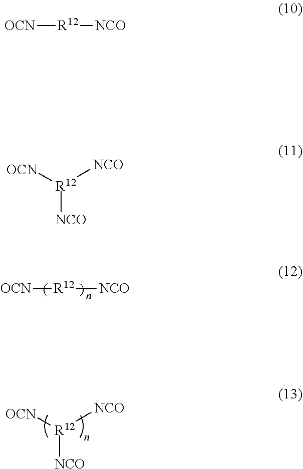
wherein R¹² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and n is an integer from 1 to 30; 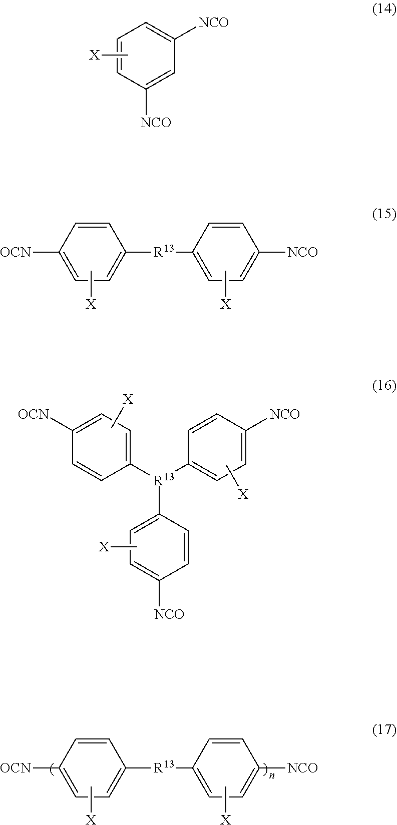
wherein X represents a substituent, or different substituents and are selected independently from the group consisting of hydrogen, halogen and linear or branched C1-C6 alkyl groups, attached on their respective phenyl ring at the 2-position, 3-position or 4-position, and their respective isomers, and R¹³ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and n is an integer from 1 to 30; 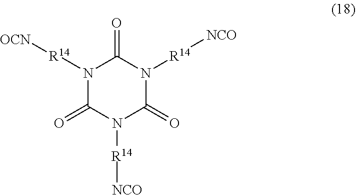
wherein R¹⁴ is alkyl group having 1-10 carbon atoms; 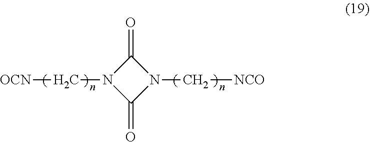
wherein n is an integer having a mean value from 2 to 18; 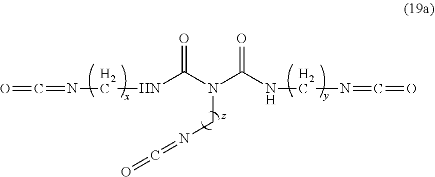
wherein x, y and z are same or different and have a value 2 to 10; 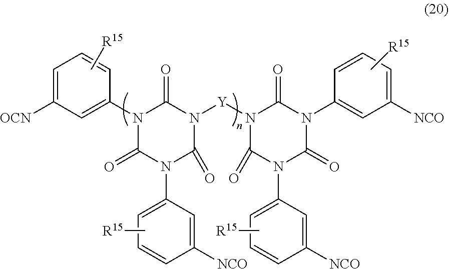
wherein R¹⁵ is selected independently from the group consisting of alkyl, hydrogen and 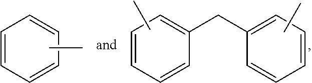
alkenyl, and Y is selected from the group consisting of and n is an integer from 0 to 3; 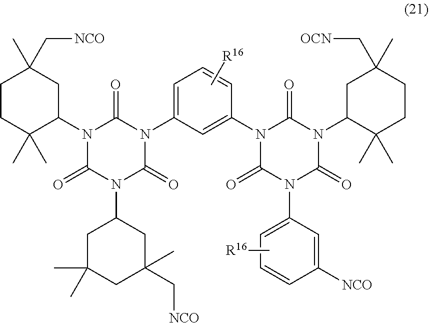
wherein R¹⁶ is selected independently from the group consisting of alkyl, hydrogen and alkenyl.

6. A benzoxazine based copolymer aerogel according to claim 1, wherein said cyclic ether compound is an epoxy compound or an oxetane compound.

7. A benzoxazine based copolymer aerogel according to claim 1, wherein said cyclic ether compound is an epoxy compound selected from the group consisting of 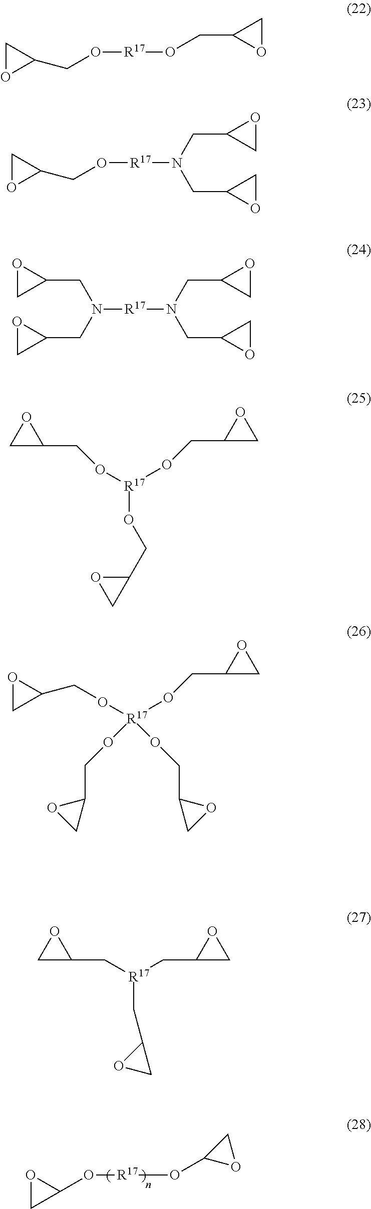
wherein R¹⁷ is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and n is an integer from 1 to 30; 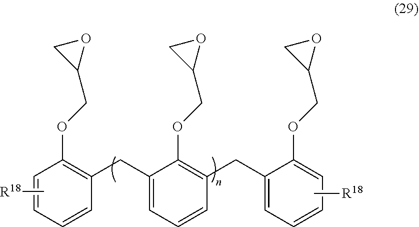
wherein R¹⁸ is selected independently from the group consisting of hydrogen, halogen, alkyl and alkenyl; and n is an integer from 1 to 10; 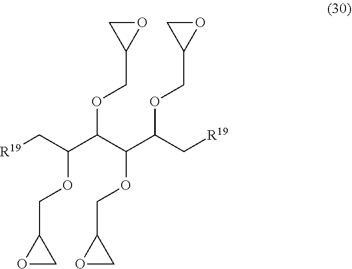
wherein R¹⁹ is selected independently from the group consisting of hydrogen, hydroxyl, halogen, alkyl and alkenyl. 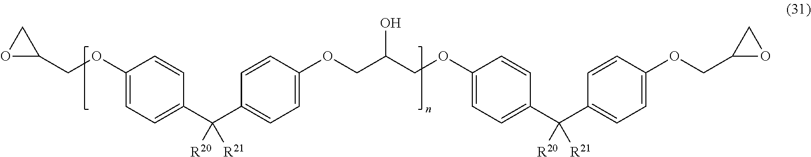
wherein R²⁰ and R²¹ are substituted or unsubstituted monovalent hydrocarbon groups or alkoxy groups and n is an integer from 0 to 16
or
said oxetane compound is selected from the group consisting of 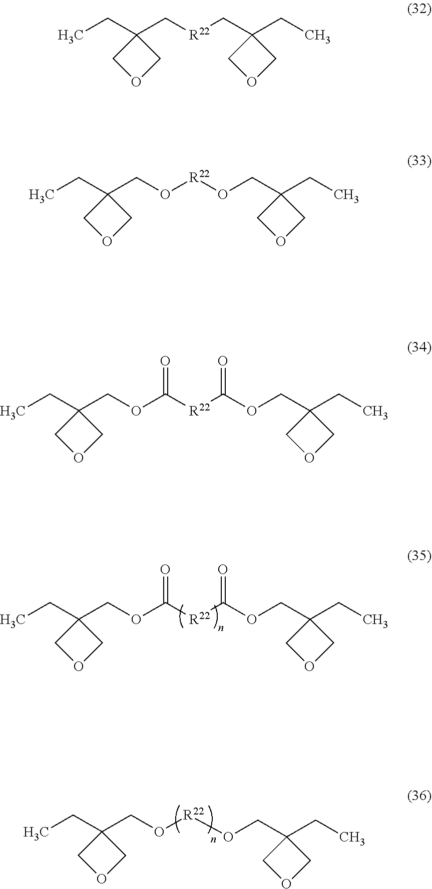
wherein R²² is selected from the group consisting of a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group; and n is an integer from 1 to 30.

8. A benzoxazine based copolymer aerogel according to claim 1, wherein said acid anhydride compound is selected from the group consisting of 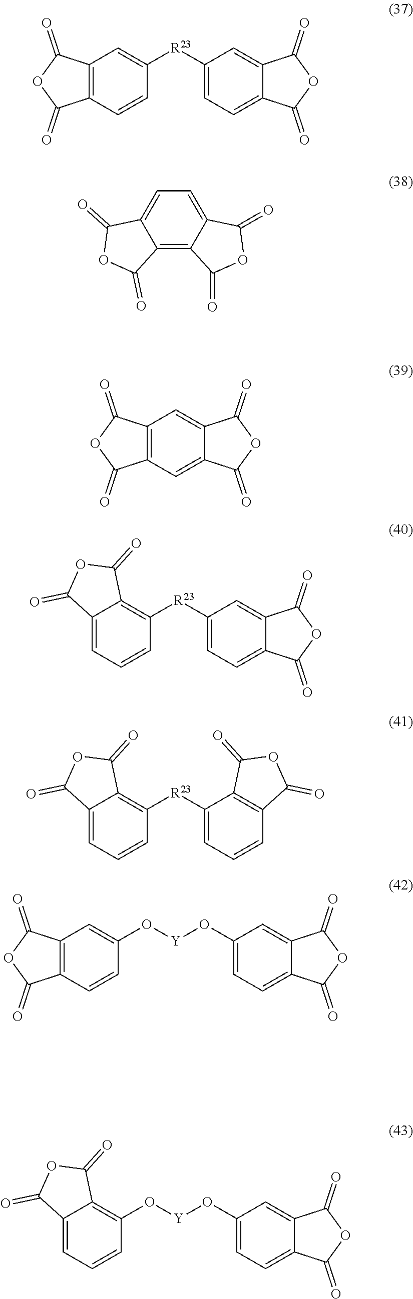 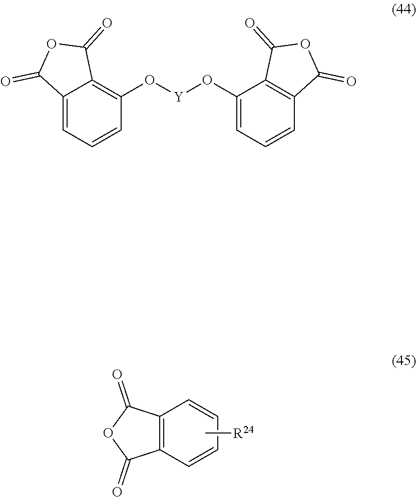
wherein R²³ is selected from the group consisting of direct bond, —CH₂—, —O—, —S—, —C(O)—, —S(O)2-, —C(CH₃)₂—, —C(CF₃)₂—, —Si(CH₃)₂— and 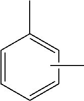
Y is selected from the group consisting of and wherein R²⁴ is selected from the group consisting of hydrogen, halogen, alkyl, alkenyl, carboxyl.

9. A benzoxazine based copolymer aerogel according to claim 1, wherein said solvent is a polar solvent or a polar aprotic solvent.

10. A benzoxazine based copolymer aerogel according to claim 1, wherein said solvent is selected from the group consisting of dimethylsulfoxide, dimethylformamide, dimethylacetamide, N-methyl-2-pyrrolidone, 1,4-dioxane and mixtures thereof.

11. A benzoxazine based copolymer aerogel according to claim 1, wherein said catalyst is selected from the group consisting of phenolic compounds, Lewis and carboxylic acids, acetylacetonate metal complexes, secondary and tertiary amines, quaternary onium salts, and mixtures thereof.

12. A benzoxazine based copolymer aerogel according to claim 1, wherein said aerogel has a solid content from 2.5 to 50%, based on initial solid content of the solution.

13. A benzoxazine based copolymer aerogel according to claim 1, wherein benzoxazine monomer or oligomer and a comonomer weight ratio is from 95% to 50% based on the total monomers in the solution.

14. A benzoxazine based copolymer aerogel according to claim 1, wherein said aerogel has a thermal conductivity less than 55 mW/m·K.

15. A process for preparing a benzoxazine based copolymer aerogel according to claim 1 comprising the steps of:
1) dissolving a benzoxazine monomer or oligomer, comonomer and a catalyst into a solvent and mixing,
2) transferring the mixture of step 1) to a sealed mould;
3) heating the solution in order to form a gel;
4) washing said gel with a solvent;
5) drying said gel by supercritical or ambient drying; and
6) postcuring of the obtained aerogel by thermal treatment.

13. A process according to claim 12, wherein temperature from room temperature to 160° C. is applied at step 3 to form a gel.

16. A process according to claim 15, wherein temperature from 150° C. to 220° C. is applied at step 6 to postcure an aerogel.

17. A thermal insulating material or an acoustic material comprising a benzoxazine based copolymer aerogel according to claim 1.

18. A benzoxazine based copolymer aerogel according to claim 1 as a thermal insulating material or acoustic material.

19. A benzoxazine based copolymer aerogel according to claim 18 as a thermal insulating material for the storage of cryogens.
